(19) United States
(12) Patent Application Publication
(10) Pub. No.: US 2018/0199552 A1
(43) Pub. Date: Jul. 19, 2018

(54) HOOKED ON FISHING LURE/SPINNER BAIT

(71) Applicant: Michelle Treiber, Curtis, MI (US)

(72) Inventor: Michelle Treiber, Curtis, MI (US)

(21) Appl. No.: 15/924,258

(22) Filed: Mar. 18, 2018

(51) Int. Cl. A01K 85/10; A01K 83/00

(52) U.S. Cl. CPC A01K 85/10; A01K 83/00

(57) ABSTRACT

A fishing lure for attracting predatory fishes to a fishing line is disclosed. The fishing lure is designed as a spinnerbait capable of flashing, spinning and floating when drifted underwater for attracting the predatory fishes consistently. The fishing lure comprising a main body with a central axis and a plurality of components assembled on the central axis. The plurality of components includes blades, floats, beads, wedding band beads, hooks and dressings capable of flashing, spinning and floating underwater. The fishing lure further comprises a weighted body for withstanding water currents. Further, the fishing lure is capable of being utilized as a jig when used in one of a boat, an off a dock, shoreline and through ice.

### BACKGROUND

### Technical Field

The embodiments herein are generally related to a fishing equipment. The embodiments herein are particularly related to a fishing line or bait for attracting fishes during fishing. The embodiments herein are more particularly related to a spinner (spinning) bait that floats, spins, and flashes in water to attract predatory fishes.

### Description of the Related Art

Fishing has been practiced since centuries for livelihood and as a competition. Fishing competition is a highly popular game in different parts of the world. The success in fishing depends on equipment and tactics used by an angler/fishing during such competitions. Hence there has been a lot of innovations in the equipments used for fishing. One such equipment is a fishing lure/line/bait that stimulates appearance and actions of a prey or fish bait. The fishing lure/line mimics physical or organic characteristics of the prey including movement, vibration, flash and color.

At times, a use of live baits become costly and unpleasant to work with. Therefore, a demand for artificial fish baits/fishing lure is increased among the anglers. The artificial fish baits/fishing lure is attached at the end of a fishing line to attract fishes to the fishing line to trap and catch the fishes. The artificial fish baits/fishing lures are of different types based on the physical or organic characteristics stimulated by them. The fishing lure resembles a prey for the fishes due to the physical or organic characteristics exhibited.

The different type of fishing lures includes jigs, surface lures, spinnerbaits, swimbaits and the like. The jigs are weighted hooks with a lead head and a sharp tip that exhibits up and down movements when drifted underwater. Surface lures floats and make a popping, burbling or a buzzing sound to appear like a prey on the top of the water. Further spinnerbaits are generally a piece of wire loaded with a hook and flashy spinners to exhibit the appearance of a prey. Swimbaits are soft plastic lures with a tail that resembles an actual fish swimming underwater. Even though all the different types of baits are effective in their modes of operation, none of the fishing lures provides a slow floating and spinning movement in two side directions by consistently attracting fishes while drifting underwater.

Hence, there is a need for a fishing lure/bait capable of consistently attracting fishes underwater by mimicking an appearance of a natural prey. There is also a need for a fishing lure capable of floating and spinning on both directions. Further, there is a need for a fishing lure that flashes, spins and floats to attract predatory fishes to fishing line.

The above-mentioned shortcomings, disadvantages, and problems are addressed herein and which will be understood by reading and studying the following specification.

### OBJECTIVES OF THE EMBODIMENTS HEREIN

The primary object of the embodiments herein is to provide a new fishing lure capable of consistently attracting fishes underwater by mimicking an appearance of a natural prey.

Another object of the embodiments herein is to provide a spinnerbait with a floating and spinning body that appears as a natural prey when floating through water to attract predatory fishes.

Yet another object of the embodiments herein is to provide a fishing lure capable of floating and spinning on both directions.

Yet another object of the embodiments herein is to provide a fishing lure that flashes, spins and floats to attract predatory fishes to fishing line

Yet another object of the embodiments herein is to provide a spinner bait that with a main body that floats and spins in either direction.

Yet another object of the embodiments herein is to provide a spinnerbait loaded with floats, beads, wedding band beads, hooks, blades and dressings.

Yet another object of the embodiments herein is to provide a spinnerbait loaded with the beads and blades designed in appropriate sizes such that the spinnerbait spins freely with ease.

Yet another object of the embodiments herein is to provide a spinnerbait loaded with the beads and blades designed in appropriate sizes to attract predatory fishes easily.

Yet another object of the embodiments herein is to provide a spinnerbait capable of being used as a jig when used on any one of a boat, a dock, shoreline and through ice.

Yet another object of the embodiments herein is to provide a spinnerbait loaded with a weighted body to prevail, withstand and overcome the water currents.

These and other objects and advantages of the embodiments herein will become readily apparent from the following detailed description taken in conjunction with the accompanying drawings.

### SUMMARY OF THE EMBODIMENTS HEREIN

The embodiments herein provide a fishing lure for consistently attracting more fishes to a fishing line laid by an angler. The fishing lure or the spinnerbait floats and spins in either direction under the water, thereby attracting fishes to fishing line laid by the angler.

According to an embodiment herein, a fishing lure device is disclosed. The fishing lure device includes a main body comprising a central axis and a plurality of components assembled on the central axis. Each component among the plurality of components comprises an orifice for accommodating/receiving the central axis. The plurality of components includes blades, floats, beads, wedding band beads, hooks and dressings. The plurality of components is assembled on the central axis in the order of a first bead, a blade(s), a second bead, a float, a third bead, a fourth bead, a wedding band bead, a fifth bead, a sixth bead, a hook and a dressing.

According to an embodiment herein, the main body is configured to float and spin in two side directions.

According to an embodiment herein, the central axis is made of material selected from a group consisting of a metal wire, thread, and plastic wire.

According to an embodiment herein, the plurality of components is designed or arranged in a color selected from a group of colors consisting of red, blue, green, and colors formed by a combination of a red, green or blue or any combination of colors thereof.

According to an embodiment herein, the first bead, the second bead, the third bead and the sixth bead are designed to have a first preset size, and wherein the first preset size is four millimeter in diameter.

According to an embodiment herein, the fourth bead and the fifth bead is are designed to have a second preset size, and wherein the second preset size is six millimeter in diameter.

According to an embodiment herein, the first bead, the second bead, the third bead, the fourth bead, the fifth bead and the sixth bead are configured/designed to act as a flash.

According to an embodiment herein, the blade(s) are configured to spin in either directions or both the directions. Both the directions include a clockwise direction and a counter clockwise direction.

According to an embodiment herein, the float is configured to spin in two side directions. Both the side directions include a clockwise direction and a counter clockwise direction.

According to an embodiment herein, the wedding band beads are configured to act as a flash and spin in two side directions. Both the directions include a clockwise direction and a counter clockwise direction.

According to an embodiment herein, the main body is further attached to a weighted body to prevail, withstand and strong currents in water bodies.

According to an embodiment herein, the fishing lure is configured to be utilized as a spinnerbait with bottom bouncers.

According to an embodiment herein, the fishing lure is further configured to act as a jig when used in any one of a boat, an off a dock, shoreline and through ice.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will be apparent to those skilled in the art from the following description of the preferred embodiment herein and the accompanying drawings in which:

FIG. 1A illustrates a side view of a fishing lure, according to one embodiment herein.

FIG. 1B illustrates a side view of a fishing lure, according to one embodiment herein.

FIG. 1C illustrates a side view of a fishing lure, according to one embodiment herein.

FIG. 1D illustrates a side view of a fishing lure, according to one embodiment herein.

FIG. 1E illustrates a side view of a fishing lure, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein provide a fishing lure for consistently attracting more fishes to a fishing line laid by an angler. The fishing lure or the spinnerbait floats and spins in either direction under the water, thereby attracting fishes to fishing line laid by the angler.

According to an embodiment herein, a fishing lure device is disclosed. The fishing lure device includes a main body comprising a central axis and a plurality of components assembled on the central axis. Each component among the plurality of components comprises an orifice for accommodating/receiving the central axis. The plurality of components includes blades, floats, beads, wedding band beads, hooks and dressings. The plurality of components is assembled on the central axis in the order of a first bead, a blade(s), a second bead, a float, a third bead, a fourth bead, a wedding band bead, a fifth bead, a sixth bead, a hook and a dressing.

According to an embodiment herein, the main body is configured to float and spin in two side directions.

According to an embodiment herein, the central axis is made of material selected from a group consisting of a metal wire, thread, and plastic wire.

According to an embodiment herein, the plurality of components is designed or arranged in a color selected from a group of colors consisting of red, blue, green, and colors formed by a combination of a red, green or blue or any combination of colors thereof.

According to an embodiment herein, the first bead, the second bead, the third bead and the sixth bead are designed to have a first preset size, and wherein the first preset size is four millimeter in diameter.

According to an embodiment herein, the fourth bead and the fifth bead is are designed to have a second preset size, and wherein the second preset size is six millimeter in diameter.

According to an embodiment herein, the first bead, the second bead, the third bead, the fourth bead, the fifth bead and the sixth bead are configured/designed to act as a flash.

According to an embodiment herein, the blade(s) are configured to spin in either directions or both the directions. Both the directions include a clockwise direction and a counter clockwise direction.

According to an embodiment herein, the float is configured to spin in two side directions. Both the side directions include a clockwise direction and a counter clockwise direction.

According to an embodiment herein, the wedding band beads are configured to act as a flash and spin in two side directions. Both the directions include a clockwise direction and a counter clockwise direction.

According to an embodiment herein, the main body is further attached to a weighted body to prevail, withstand and strong currents in water bodies.

According to an embodiment herein, the fishing lure is configured to be utilized as a spinnerbait with bottom bouncers.

According to an embodiment herein, the fishing lure is further configured to act as a jig when used in any one of a boat, an off a dock, shoreline and through ice.

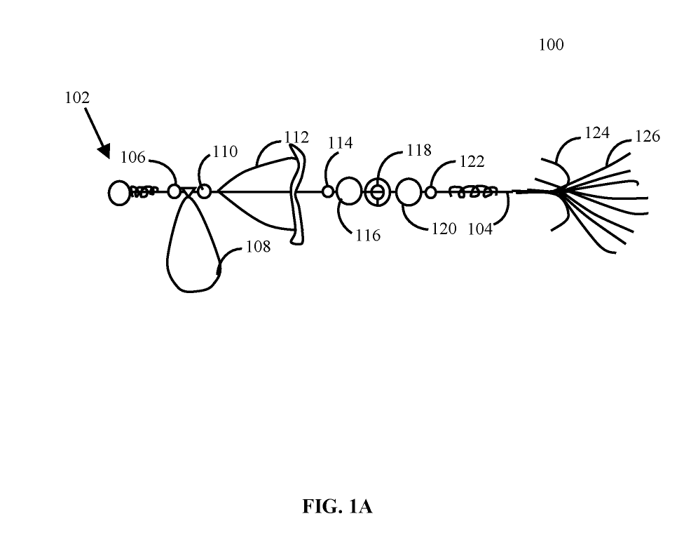

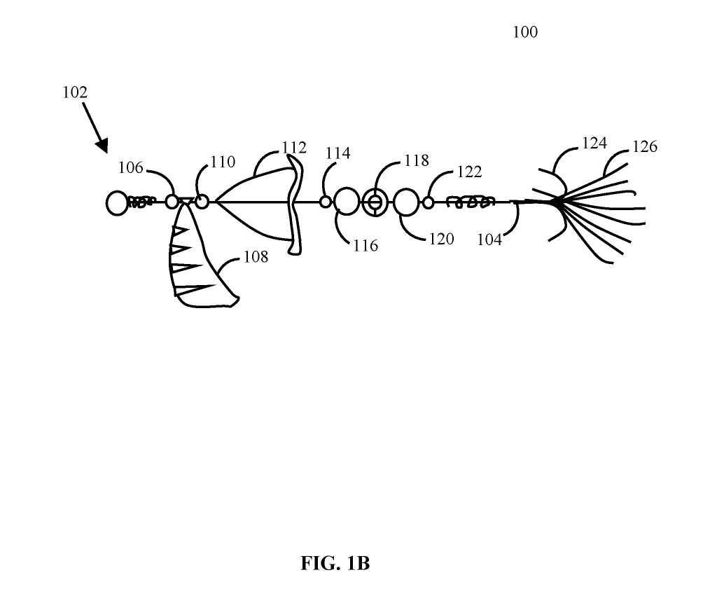

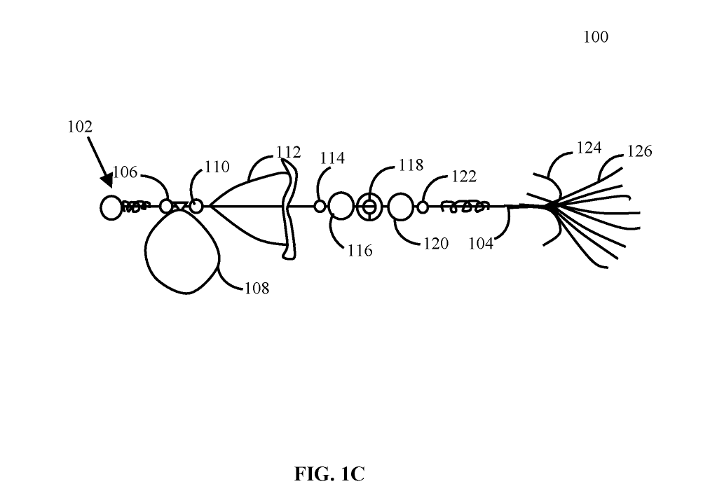

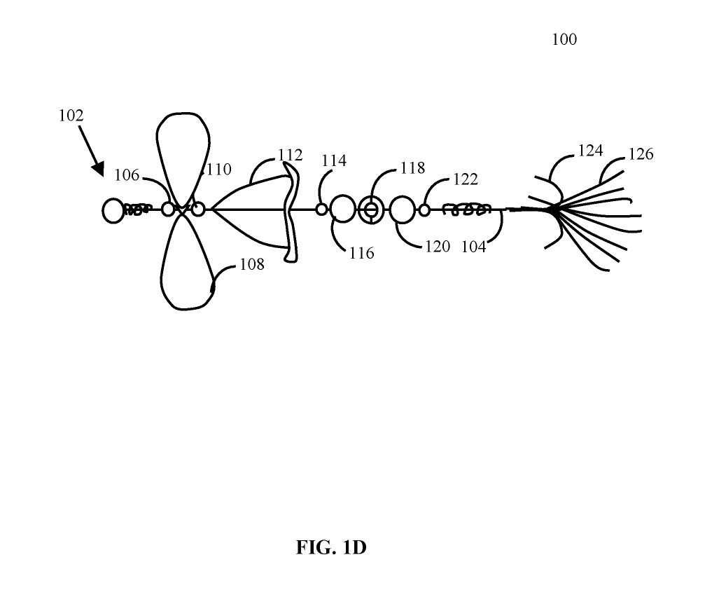

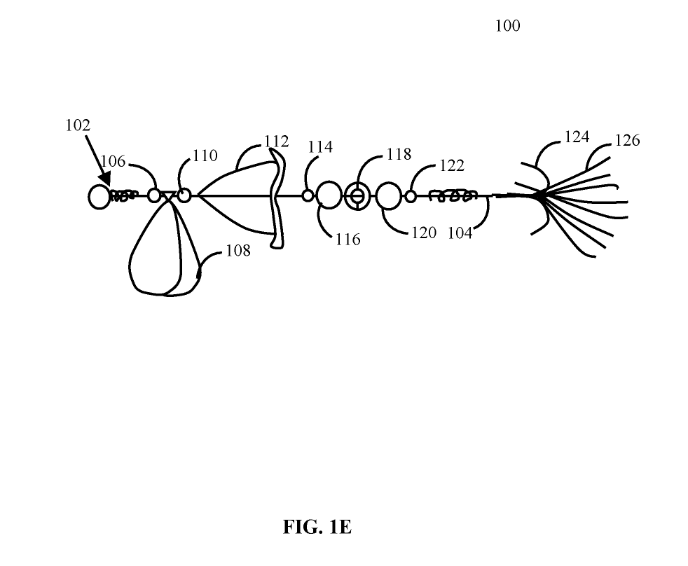

FIG. 1A-FIG. 1E illustrates different designs of a fishing lure having a same working principle. The fishing lure 100 is designed such that underwater predatory fishes are attracted to a fishing line laid by an angler. The examples of predatory fishes include but are not limited to walleye, perch, pike and bass. The fishing lure 100 is designed to mimic the physical characteristics of a live bait/prey including colors and movements. The fishing lure 100 is designed to flash, spin and float in water to attract the predatory fishes. The fishing lure 100 in one embodiment is designed as a spinnerbait to be utilized in conjunction with bottom bouncers.

The fishing lure 100 comprises a main body 102 made of a central axis 104 and a plurality of components 106, 108,110 . . . 126 that are assembled on the central axis 104. The central axis 104 of the main body 100 is formed of materials including but not limited to metal wires, threads, plastic wires and the like. The plurality of components 106, 108, . . . 126 include but are not limited to blades, floats, beads, wedding band beads, hooks and dressings, etc. The main body 102 of the fishing lure 100 comprises the ring 128 at one end for attaching the fishing lure 100 to the fishing line. Further, the main body 102 comprises the hook 124 for trapping or catching fishes attached to the fishing lure 100. According to one embodiment herein, the hook 124 is designed as a camouflaged hook. The plurality of components 106, 108 . . . 126 are assembled on the metal wire 104 in the order of a first bead 106, a blade(s) 108, a second bead 110, a float 112, a third bead 114, a fourth bead 116, a wedding band bead 118, a fifth bead 120, a sixth bead 122, a hook 124 and a dressing 126.

According to one embodiment herein, the plurality of components 106, 108, 110 . . . 126 are provided with a body color of fishes to attract the predatory fishes underwater. The colors of the plurality of components 106, 108 . . . 126 are selected from a group of colors including red, blue, green, or colors formed by a combination of a red, blue and green. The first bead 106, the second bead 110, the third bead 114, the fourth bead 116, the fifth bead 120 and the sixth bead 122 are configured to act as a flash for attracting predatory fishes to the angler's fishing line. The first bead 106, the second bead 110, the third bead 114, the fourth bead 116, the fifth bead 120 and the sixth bead 122 are provided with fluorescent bright colors to act as flash underwater. Further, the wedding band beads 118 are also configured to act as a flash. The wedding band beads 118 comprises stones with bright colors to act as flash underwater. Further, the dressing 126 is made of hair or feathers of different colors to attract the predatory fishes. Further, the dressing 126 is used to cover the hook 124. Thus, the fishing lure 100 mimic the colors of the live bait/prey, thereby attracting predator fishes to fishing line of the angler.

Further, each component among the plurality of components 106, 108 . . . 126 is configured to float and spin when the fishing line is lowered and drifted or trolled over bottom surface of the water. The blade(s) 108 are configured to spin in either directions. The blade(s) 108 comprises either a single blade or multiple blades that spins in either directions. Further, the blade(s) 108 is of different shapes as shown in FIG. 1A-FIG. 1E. The float 112 is also configured to spin in either direction. The float 112 is of different shapes including but not limited to twisted, pill or round shape. Further, the wedding band beads 118 are configured to spin in either direction.

The first bead 106, the second bead 110, the third bead 114, the fourth bead 116, the fifth bead 120 and the sixth bead 122 also spin in either direction. The first bead 106, the second bead 110, the third bead 114, and the sixth bead 122 are four millimeter in diameter. The fourth bead 116 and the fifth bead 120 are six millimeters in diameter. The four millimeter size of the first bead 106, the second bead 110, the third bead 114, and the sixth bead 122 enable easy spinning compared to beads with large sizes. The size of all the beads including first bead 106, the second bead 110, the third bead 114, the fourth bead 116, the fifth bead 120 and the sixth bead 122 are designed for spinning ease and ability to attract predatory fishes. Therefore, the fishing lure 100 floats and spins in either direction. The plurality of components 106, 108 . . . 126 that flashes, spins and floats provides the appearance of natural minnows or crawlers for drawing the predatory fishes to fishing line and gets the predatory fishes to bite on the hook 124.

Further, the fishing lure 100 comprises a weighted body (not shown in the figure) attached to the main body 102. The weighted body is a weight configured to help the fishing lure 100 to overcome, and withstand strong water currents. Further, the number of additional weighted body added depends on the prevalent water currents are. Thus the fishing lure 100 is configured to catch fishes under water when used in conjunction with a bottom bouncer. The fishing lure 100 is designed to serve for a plurality of purposes. For example, the fishing lure 100 with a weighted body acts as a jig when used in a boat, off a dock, shoreline or through the ice. When used as a jig, the fishing lure 100 creates a jerky and vertical movements. The fishing lure 100 spins and flashes to attract the predatory fishes when used as a jig

Therefore, the fishing lure 100 is capable of flashing, spinning and floating in water, thereby appearing as a natural prey or presenting a natural appearance of a prey to the predatory fishes. The fishing lure 100 flashes to draw the attention of the predatory fishes far away from the fishing line. The fishing lure 100 further floats and spins slowly by consistently attracting the predatory fishes to the fishing line until they are trapped. The fishing lure 100 utilizes floats of for enabling floating of the main body 102.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A fishing lure comprising:
a main body comprising a central axis and a plurality of components assembled on the central axis;
wherein each component among the plurality of components comprises a orifice for accommodating the central axis, and wherein the plurality of components includes blades, floats, beads, wedding band beads, hooks and dressings, wherein the plurality of components is assembled on the central axis in the order of a first bead, a blade(s), a second bead, a float, a third bead, a fourth bead, a wedding band bead, a fifth bead, a sixth bead, a hook and a dressing.

2. The fishing lure as claimed in claim 1, wherein the main body is configured to float and spin in two side directions.

3. The fishing lure as claimed in claim 1, wherein the central axis is made of material selected from a group consisting of a metal wire, thread, and plastic wire.

4. The fishing lure as claimed in claim 1, wherein the plurality of components is formed or designed in a color selected from a group of colors consisting of red, blue, green, and any color formed by a combination of a red, green or blue.

5. The fishing lure as claimed in claim 1, wherein the first bead, the second bead, the third bead and the sixth bead are designed to have a first preset size, and wherein the first preset size is four millimeter in diameter.

6. The fishing lure as claimed in claim 1, wherein the fourth bead and the fifth bead are designed to have a second preset size, and wherein the second preset size is six millimeter in diameter.

7. The fishing lure as claimed in claim 1, wherein the first bead, the second bead, the third bead, the fourth bead, the fifth bead and the sixth bead are configured to act as a flash.

8. The fishing lure as claimed in claim 1, wherein the blade(s) are configured to spin in two directions, and wherein the two directions are clockwise direction and counter clockwise direction.

9. The fishing lure as claimed in claim 1, wherein the float is configured to spin in two directions, and wherein the two directions are clockwise direction and counter clockwise direction.

10. The fishing lure as claimed in claim 1, wherein the wedding band beads are configured to act as a flash and spin in two directions, and wherein the two directions are clockwise direction and counter clockwise direction.

11. The fishing lure as claimed in claim 1, wherein the main body is further attached with a weighted body to withstand and overcome currents in water bodies.

12. The fishing lure as claimed in claim 1, wherein the fishing lure is configured to act as a spinnerbait with bottom bouncers.

13. The fishing lure as claimed in claim 1, wherein the fishing lure is further configured to act as a jig when used in one of a boat, an off a dock, shoreline and through ice.
